(19) United States
(12) Patent Application Publication
(10) Pub. No.: US 2020/0384626 A1
(43) Pub. Date: Dec. 10, 2020

(54) MULTI-TASK TOOL ASSEMBLY WITH LOAD TENSION ASSEMBLY

(71) Applicant: USA Products Group Inc., Lodi, CA (US)

(72) Inventor: Manuel Lopez, Lodi, CA (US)

(73) Assignee: USA Products Group Inc., Lodi, CA (US)

(21) Appl. No.: 15/984,377

(22) Filed: May 20, 2018

(51) Int. Cl. B25F 1/04; B25F 1/00

(52) U.S. Cl. CPC B25F 1/04; B25F 1/006

(57) ABSTRACT

A multi-task tool assembly comprising an enclosure having a first side and second side; an attachment device connected within the enclosure between the first side and the second side at a first end of the enclosure and rotatable from a retracted position outward relative to the enclosure to an extended position; and a load tension assembly connected within the enclosure between the first side and the second side at a second end of the enclosure, is disclosed herein.

### BACKGROUND

The present disclosure relates generally to a multi-task tool, and more particularly to a multi-task tool assembly having, among other things, a load tension assembly for securing, supporting, lifting, or moving a load in an efficient and effective manner.

Tool assemblies such as those provide by Leatherman® include multiple tools such as a screwdriver, nail file, knife, wire cutter, awl, scissor, etc. These devices may be used for a multitude of endeavors and the assembly provides for convenient storage of the tools. Although such tool assemblies are well known, the assemblies fail to include a load tension assembly. As such, it would be desirable to provide a multi-task tool assembly having, among other things, a load tension assembly for securing, supporting, lifting, or moving a load in an efficient and effective manner.

### SUMMARY

For purposes of summarizing the disclosure, exemplary concepts have been described herein. It is to be understood that not necessarily all such concepts may be achieved in accordance with any particular embodiment. Thus, for example, those skilled in the art will recognize that embodiments may be carried out in a manner that achieves or optimizes one concept as taught herein without necessarily achieving other concepts as may be taught or suggested herein.

In one embodiment, a multi-task tool assembly comprises an enclosure having a first side and second side; an attachment device connected within the enclosure between the first side and the second side at a first end of the enclosure and rotatable from a retracted position outward relative to the enclosure to an extended position; and a load tension assembly connected within the enclosure between the first side and the second side at a second end of the enclosure.

In another embodiment, a multi-task tool assembly comprises a multi-task tool assembly comprising an enclosure having a first side and second side; one or more tools and an attachment device connected between the first side and the second side at a first end of the enclosure and rotatable from a retracted position outward relative to the enclosure to an extended position; and a load tension assembly connected within the enclosure between the first side and the second side at a second end of the enclosure.

These and other embodiments will become apparent to those skilled in the art from the following detailed description of the various embodiments having reference to the attached figures, the disclosure not being limited to any particular embodiment.

### BRIEF DESCRIPTION OF THE DRAWINGS

FIG. 1A shows perspective views of a multi-task tool assembly including an attachment device in a retracted position in accordance with one embodiment disclosed herein.

FIG. 1B shows perspective views of a multi-task tool assembly including an attachment device in a extended position in accordance with one embodiment disclosed herein.

FIGS. 2A-2D show different views of the multi-task tool assembly in accordance with one embodiment disclosed herein.

FIG. 3 shows an exploded view of the multi-task tool assembly in accordance with one embodiment disclosed herein.

FIG. 4A shows a load tension assembly of the multi-task tool assembly with a trigger mechanism in a secure position in accordance with one embodiment disclosed herein.

FIG. 4B shows the load tension assembly of the multi-task tool assembly with a trigger mechanism in a release position in accordance with one embodiment disclosed herein.

FIGS. 5A-5E show various views of a multi-task tool assembly in accordance with another embodiment disclosed herein.

FIG. 5F shows the multi-task tool assembly in accordance with still another embodiment disclosed herein.

FIG. 6 shows an exploded view of the multi-task tool assembly in accordance with the embodiment disclosed in FIGS. 5A-5E herein.

FIGS. 7A and 7B show a load tension assembly trigger of the multi-task tool assembly with a trigger mechanism in a secure position in accordance with the embodiment disclosed in FIGS. 5A-5F herein.

FIGS. 7C and 7D show a load tension assembly of the multi-task tool assembly with a trigger mechanism in a release position in accordance with the embodiment disclosed in FIGS. 5A-5F herein.

### DETAILED DESCRIPTION

Exemplary embodiments will now be described with references to the accompanying figures, wherein like reference numbers refer to like elements throughout. The terminology used in the description presented herein in not intended to be interpreted in any limited or restrictive manner simply because it is being utilized in conjunction with a detailed description of certain embodiments. Furthermore, various embodiments (whether or not specifically described herein) may include novel features, no single one of which is solely responsible for its desirable attributes or which is essential to practicing any of the embodiments herein described.

The present disclosure relates generally to a multi-task tool, and more particularly to a multi-task tool having, among other things, a load tension assembly for securing, supporting, lifting, or moving a load or object in an efficient and effective manner.

As used herein, the term “hub” is intended to include a spindle, a spool, a sheave, or a similar type article(s) that is configured or may be adapted to permit rotation of the hub to facilitate tensioning of a “strap” used for the purpose of applying tension to secure a “load”.

As used herein, the term “strap” is intended to include a line, a rope (round synthetic, natural fiber, metal), a cable, a cord, a flat line (webbing), an anchor line or tensioning line, or a similar type of article(s) that may be adapted to be used with the load tension assembly disclosed herein for the purpose of applying tension, herein referred to as a “load tension”, to secure a “load”.

As used herein, the term “load” is intended to include any item or object that are generally secured to prevent movement of the item(s) while in a static position, or while being moved or transport from one position to another position.

The load tension assembly described herein provides, among other things, an attachment device and a trigger mechanism for securing, supporting, lifting, or moving a load in an efficient and effective manner.

Various parts, elements, components, etc, of the multi-task tool assembly disclosed herein may be constructed from metal, plastic, composite, or other suitable material or combination thereof for providing a rigid and sturdy structure to facilitate tensioning of a line for the purpose of securing, supporting, lifting, or moving a load.

The actual size and dimension of any and all of the various parts, elements, components, etc., of the multi-task tool assembly may vary depending on various factors including, among other things, intending application or usage of the assembly, as well as the size of the load to be secured or prevented from moving while in a static position, or while being moved or transport from one position to another position.

Connection(s) between the various parts, elements, components, etc., of the multi-task tool assembly may be accomplished using a variety of methods or processes. As such, the connections, whether integral and created via bending, or form molding, for example, or connected via bonding, hardware (nuts, bolts, washers, etc.), welding, or similar techniques, are well known in the art and omitted for simplicity.

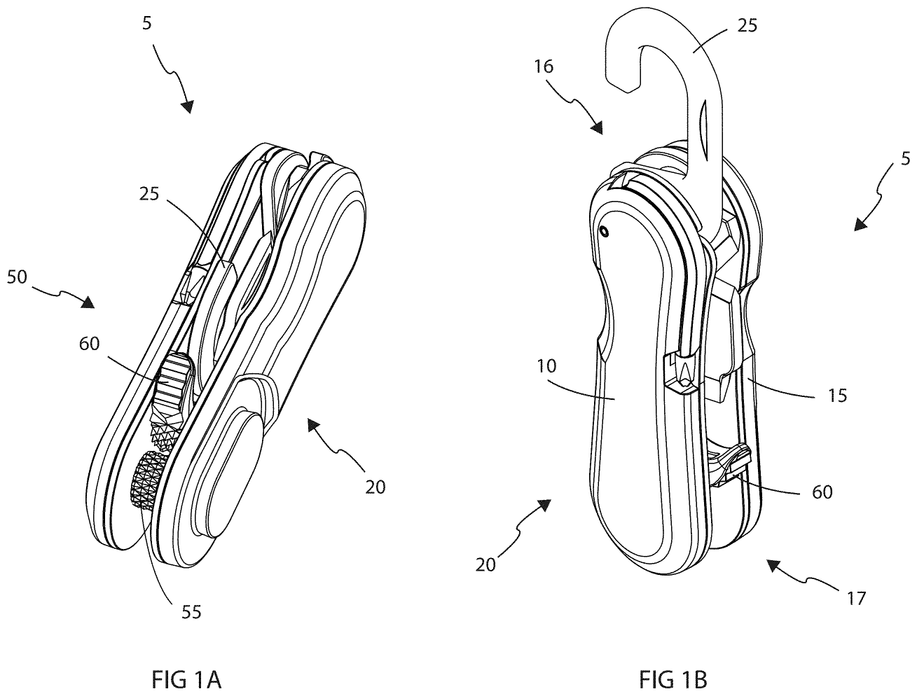

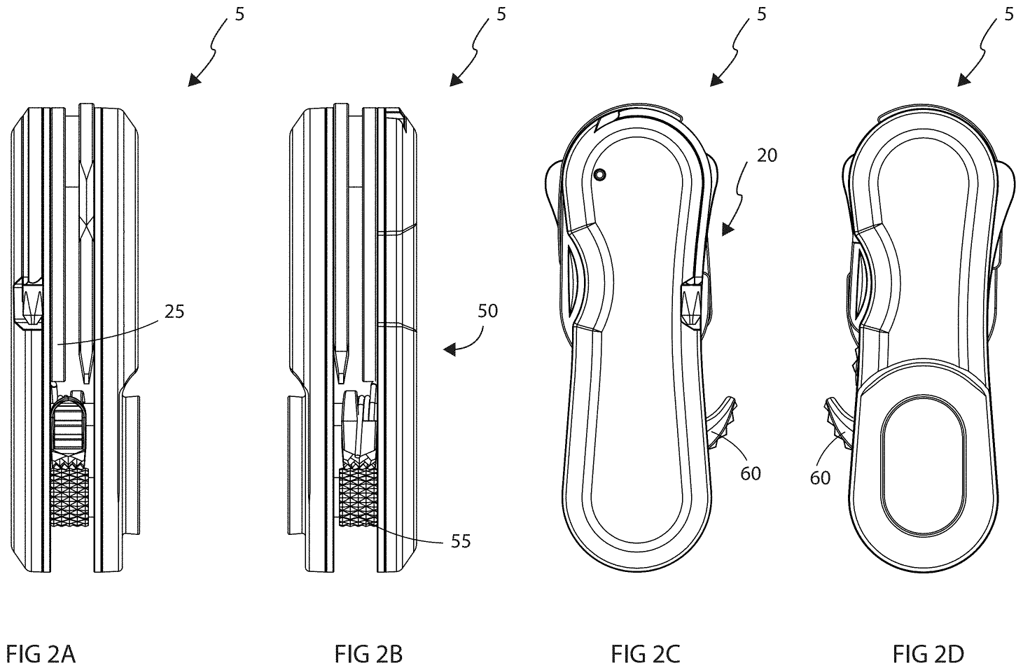

The multi-task tool assembly provides an enclosure for various tools, an attachment device, and a load tension assembly for securing, supporting, lifting, or moving a load in an efficient and effective manner. FIG. 1A shows a perspective view of a multi-task tool assembly with the tools and the attachment device in a retracted position within the enclosure. The enclosure provides a sturdy structure to protect the tools including the load tension assembly from damage and contaminants, as well as providing compact and convenient storage of the tools and load tension assembly. FIG. 1B shows a perspective view of the multi-task tool assembly with an attachment device in an extended position. In this regard, the attachment device is rotated from the retracted position outward to the extended position relative to the enclosure. FIGS. 2A-2D show different views of the multi-task tool assembly including the load tension assembly of FIGS. 1A and 1B.

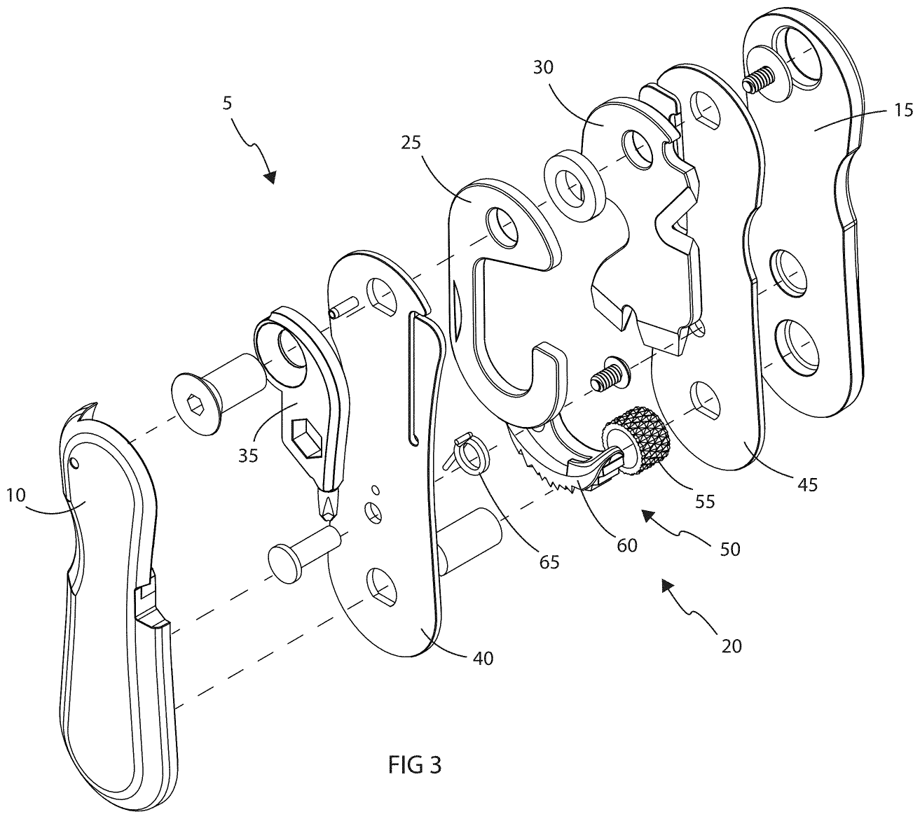

FIG. 3 shows an exploded view of the multi-task tool assembly in accordance with one embodiment disclosed herein. The multi-task tool assembly 5 includes a first side 10 and a second side 15 that form an enclosure 20 where components, hardware elements, tools, and load tension assembly are disposed within the enclosure and between the first side 10 and the second side 15. The first side 10 is positioned opposite to the second side 15. As shown in FIG. 1B, the first side 10 and the second side 15 share a common first end 16 and share a common second end 17 opposite to the first end 16.

The multi-task tool assembly 5 further includes the attachment device 25 and may include tools such as a box cutter 30 or combination screwdriver and socket adaptor 35. The attachment device 25, box cutter 30, and screwdriver 35 each include an orifice for accepting various hardware elements such as a screw, nut, spacer, washer, pin, etc., that permit the attachment device 25, box cutter 30, and screwdriver 35 to rotate about a first axis at the first end 16 of the enclosure 20 from a retracted position as shown in FIG. 1A with the enclosure between the first side 10 and second side 15 to an extended position as shown in FIG. 1B outside the enclosure 20 formed by the first side 10 and second side 15. The attachment device 25 is retained in a retracted position (FIG. 1A) at the first end 16 within the enclosure 20 between the first side 10 and second side 15 and is rotatable relative to the enclosure 20 outward or away from the enclosure 20 to a extended position (FIG. 1B). In the extended position, a terminal end of the attachment device 25 extending from the enclosure 20 may be shaped as a hook, claw, hoop, similar feature and attached or connected to a fixed point to act as an anchor to facilitate a load tension of a load tension assembly 50. Likewise, the attachment device 25 is rotatable from the extended position inward or toward the enclosure 20 to the retracted position within the enclosure 20.

The multi-task tool assembly 5 further includes a first inner sidewall 40 and a second inner sidewall 45 disposed between the first side 10 and the second side 15. The first inner sidewall 40 and the second inner sidewall 45 provide spacing and support for the multi-task tool assembly 5 and the various elements disposed between the first side 10 and the second side 15. The load tension assembly 50 is disposed within the enclosure 20 between the first inner sidewall 40 and the second inner sidewall 45 at the second end 17 of the enclosure 20. The load tension assembly 50 includes a hub 55, a trigger mechanism 60, and a tension spring 65. The load tension assembly 50 facilitates securing, supporting, lifting, or moving a load in an efficient and effective manner. In one embodiment the hub 55, trigger mechanism 60, and tension spring 65 may constitute a slip cam.

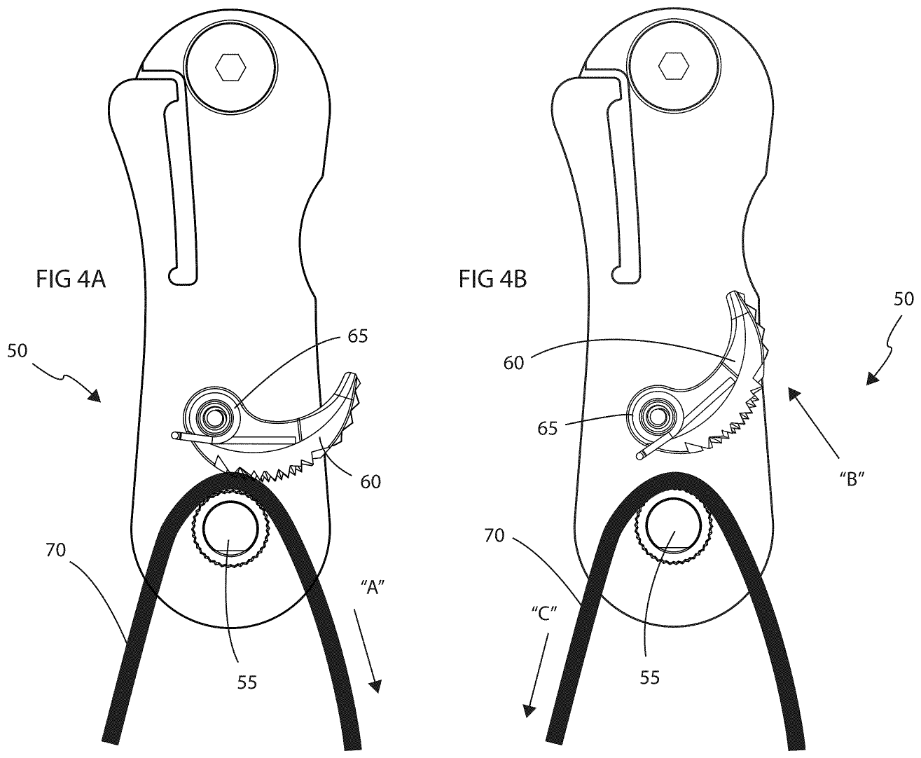

As shown in FIGS. 4A and 4B, the hub 55, trigger mechanism 60, and tension spring 65 each include an orifice for accepting various hardware elements such as a screw, nut, spacer, washer, pin, etc., which permit the hub 55, trigger mechanism 60, and tension spring 65 to rotate at the second end 17 of the enclosure 20. In this regard, the hub 55 is rotatable about a second axis at the second end 17 of the enclosure and may include a knurled surface, for example outwardly extending teeth. The tension spring 65 biases the trigger mechanism 60 toward the rotatable hub 55. The trigger mechanism 60 and the rotatable hub 55 may each include a plurality of outwardly extending teeth for engagement with a strap 70.

The trigger mechanism 60 may be rotated back and forth from a secure position to a release position shown in FIGS. 4A and 4B. As shown in FIG. 4A, in the secure position the tension spring 65 biases the trigger mechanism 60 toward the hub 55 to secure the strap 70 from moving when a load tension is applied to a load attached to one end of the strap 70. As a force is applied to the strap 70 in the direction shown by arrow “A” the tension of the tension spring 65 on the trigger mechanism 60 is overcome and the strap 70 is moved between the trigger mechanism 60 and the hub 55 to move a load. When the force in direction “A” is removed, the strap 70 is retained between the trigger mechanism 60 and the hub 55. In the secure position the trigger mechanism 60 partially extends from the enclosure 20 to provide an exposed surface for the application of a force. As shown in FIG. 4B, as a force is applied to the trigger mechanism 60 in the direction shown by arrow “B” the trigger mechanism 60 is moved away from contact with the strap 70 to the release position. In this regard when the trigger mechanism 60 is moved from the secure position to the release position, the load tension on the strap 70 due to the load moves the strap 70 in the direction shown by arrow “C”.

A method of the multi-task tool assembly 5 includes anchoring or attaching the terminal end of the attachment device 25 of the multi-task tool assembly 5 to a first point. Positioning a strap 70 such as a flat webbing, rope, chord, etc., attached to a load (not shown) between the trigger mechanism 60 and the hub 55. Applying a force to the strap 70 to move the strap 70 between the trigger mechanism 60 and the hub 55, and allowing the hub 55 to rotate. As the hub 55 rotates, a load tension is applied to the strap 70 and the load is moved. The trigger mechanism 60 is biased in the secure position to prevent rotation of the hub 55, and movement of the strap 70 in the direction of the load. When biased in the secure position the trigger mechanism 60 engages the strap 70 and forces the strap against the hub 55 to maintain the load tension and prevent movement of the load. When the trigger mechanism 60 is moved away from the strap 70 and placed in the release position the load tension placed on the line 70 from the load moves the strap 70 in the direction of the load. As such, the multi-task tool having, among other things, a load tension assembly facilitates securing, supporting, lifting, or moving a load in an efficient and effective manner.

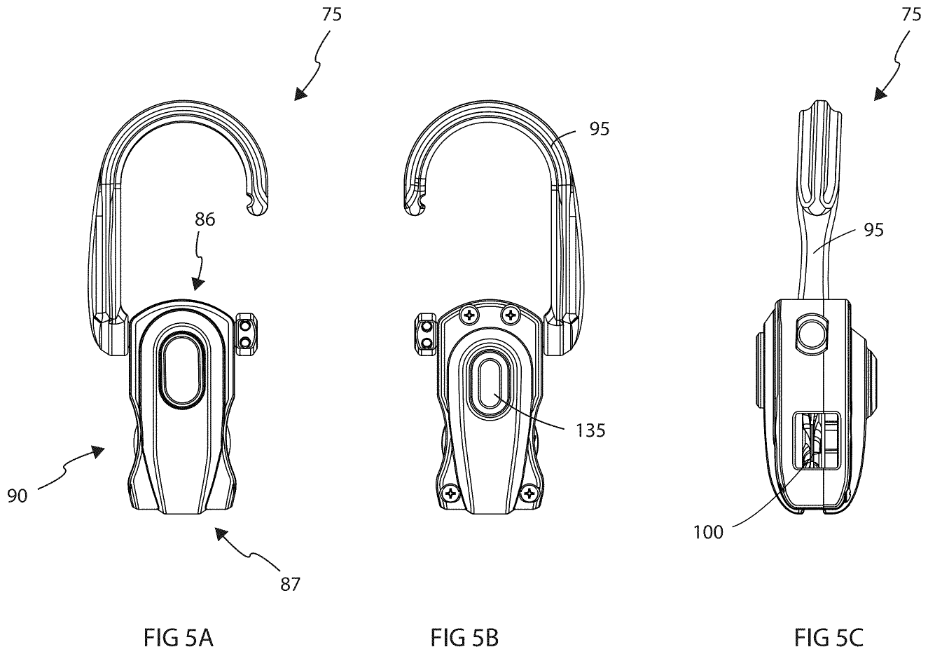

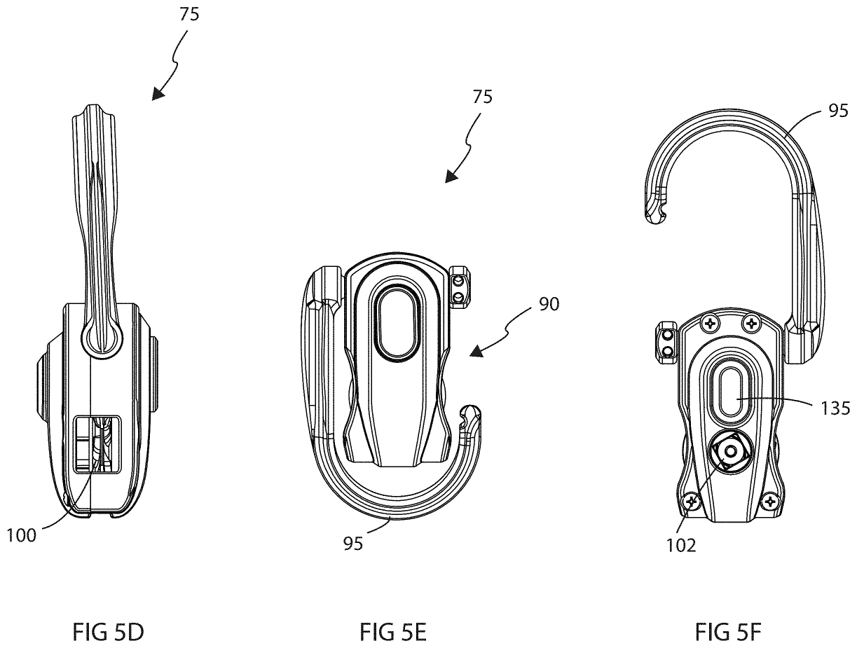

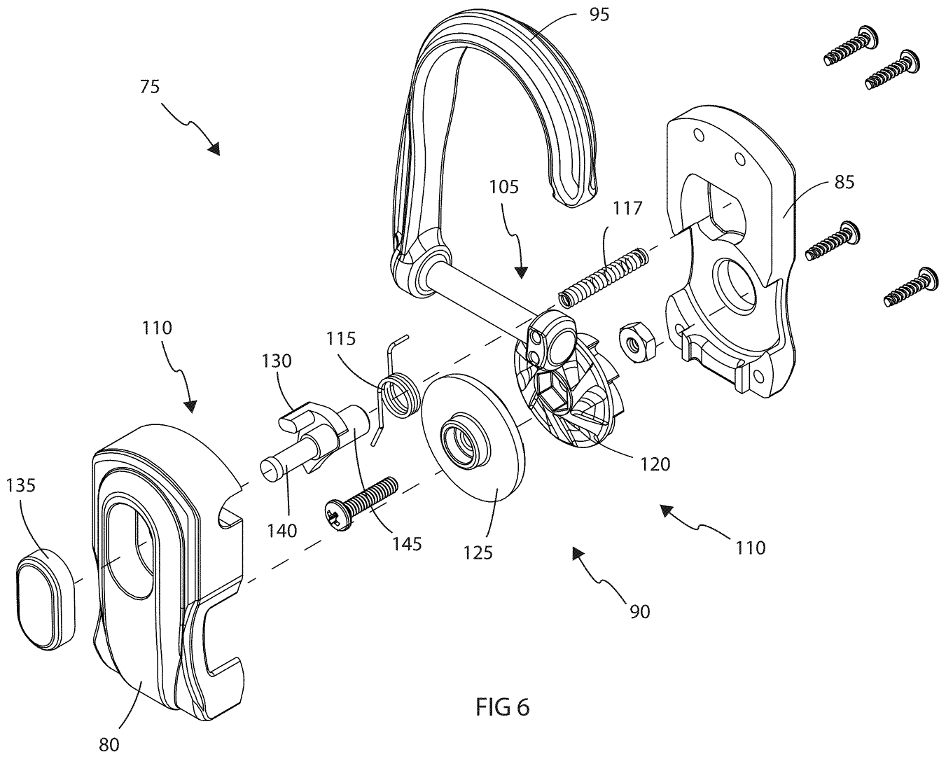

FIGS. 5A-5E show various views of a multi-task tool assembly in accordance with another embodiment disclosed herein, and FIG. 6 shows an exploded view of the multi-task tool assembly in accordance with the embodiment disclosed in FIGS. 5A-5E. As shown in FIG. 6, the multi-task tool assembly 75 includes a first side 80 and a second side 85 that form an enclosure 90 where components, hardware elements, tools, and load tension assembly are disposed within the enclosure and between the first side 80 and the second side 85. The first side 80 is positioned opposite to the second side 85. As shown in FIG. 5A, the first side 80 and the second side 85 share a common first end 86 and share a common second end 87 opposite to the first end 86.

The multi-task tool assembly 75 further includes an attachment device 95 and may include tools such as hex socket 102 (shown in FIG. 5F) as well as screw driver, knife, file, punch, etc. The attachment device 95 is retained between the first side 80 and second side 85, and is rotatable relative to the enclosure 90 about a first axis at the first end 86 of the enclosure 90 from an extended position shown in FIG. 5A inward or toward the enclosure 90 to a retracted position shown in FIG. 5E. In the retracted position the attachment device 95 may extend along the length of the enclosure 95 toward the second end 87 of the enclosure 95. In this regard, the attachment device may be positional along a side of the enclosure, encircle the second end 87, or nestle into a retaining space, for example a U-shaped space, for retaining the terminal end of the attachment device 95. Likewise, the attachment device 95 is rotatable from the retracted position outward or away from the enclosure 90 to the extended position as shown in FIG. 5F. In the extended position, a terminal end of the attachment device 95 extending from the enclosure 90 may be shaped as a hook, claw, hoop, similar feature and attached or connected to a fixed point to act as an anchor to facilitate a load tension of a load tension assembly 100.

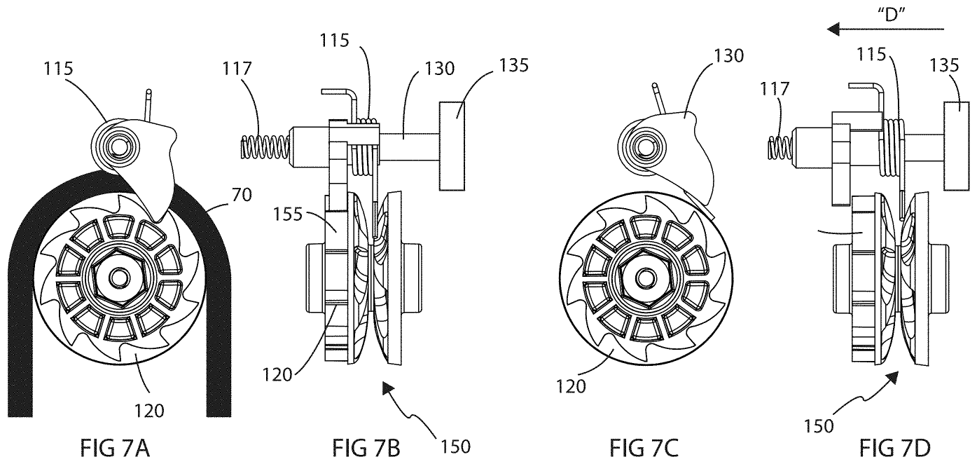

The load tension assembly 100 is disposed within the enclosure 90 between the first sidewall 80 and the second sidewall 85 at the second end 87 of the enclosure 90. The load tension assembly 100 facilitates securing, supporting, lifting, or moving a load in an efficient and effective manner. The load tension assembly 100 includes a hub 105, a trigger mechanism 110, a rotation spring 115, and a lateral spring 117. The hub 105, trigger mechanism 110, and rotation spring 115 each include an orifice for accepting various hardware elements such as a screw, nut, spacer, washer, pin, etc., which permit the hub 105 and trigger mechanism 110 to rotate at the second end of the enclosure 90, as shown in FIGS. 7A-7D.

The hub 105 is rotatable about a second axis and includes a first hub sidewall 120 and a second hub sidewall 125. The first hub sidewall 120 includes a contoured, textured, or ribbed surface positioned opposite to a contoured, textured, or ribbed surface of the second hub sidewall 125. Positioning the first hub sidewall 120 opposite to the second hub sidewall 125 forms a V-shaped groove 150. With a load attached to one end of a strap 70 (FIG. 7A), as the strap 70 is pulled through the V-shaped groove 150 a load tension is applied to the strap 70 and the strap 70 is forced into the V-shaped groove 150 of the rotatable hub 105. The ribbed surfaces and the V-shaped groove 150 formed by the first hub sidewall 120 and the second hub sidewall 125 provides surfaces to grip the strap 70 disposed between the first hub sidewall 120 and the second hub sidewall 125.

The trigger mechanism 110 includes the rotational spring 115, the lateral spring 117, and the pawl 130. A cap 135 is positioned over a first end 140 of the pawl 130, the rotation spring 115 is disposed over a second end 145 of the pawl 130, and the lateral spring 117 is disposed inside a hollow section formed in the second end 145 of pawl 130. The tension spring 115 provides rotational bias or tension to the pawl 130, and the lateral spring 117 provides lateral bias or tension to the pawl 130.

In this regard, as shown in FIGS. 7A and 7B, the lateral spring 117 urges the pawl 130 into one of a plurality of indentations 155 formed on the first hub sidewall 120. The rotation spring 115 biases the pawl 130 into one of the indentations 155 formed in the first hub sidewall 120. As such, the lateral and rotational biases or forces on the pawl 130 oppose the force created by the load tension on the strap 70 by prohibiting rotation of the hub 105 to maintain the load tension and prohibit movement of the strap 70 in the direction of the load.

As shown in FIGS. 7C and 7D, load tension is released and the strap 70 is able to move when lateral force is applied to the cap 135 in the direction shown by arrow “D”. Lateral force to the cap 135 moves the pawl 130 out of contact with one of the indentions 155 formed in first hub sidewall 120, permits the hub 105 to rotate and release of the load tension, and allows the strap 70 to move in the direction of the load. As such, the multi-task tool having, among other things, a load tension assembly facilitates securing, supporting, lifting, or moving a load in an efficient and effective manner.

Although the method(s)/step(s) are illustrated and described herein as occurring in a certain order, the specific order, or any combination or interpretation of the order, is not required. Obvious modifications will make themselves apparent to those skilled in the art, all of which will not depart from the essence of the disclosed subject matter, and all such changes and modifications are intended to be encompassed within the appended claims.

What is claimed is:

1. A multi-task tool assembly comprising:
an enclosure having a first side and second side;
an attachment device connected within the enclosure between the first side and the second side at a first end of the enclosure and rotatable from a retracted position outward relative to the enclosure to an extended position; and
a load tension assembly connected within the enclosure between the first side and the second side at a second end of the enclosure.

2. The multi-task tool assembly of claim 1, further comprising one or more tools connected within the enclosure between the first side and the second and rotatable from a retracted position outward relative to the enclosure to the extended position.

3. The multi-task tool assembly of claim 1, wherein the first side and the second side are positioned opposite to each other, and the attachment device is rotatable about a first axis.

4. The multi-task tool assembly of claim 3, where the first end and the second end are opposite to each other.

5. The multi-task tool assembly of claim 4, wherein the load tension assembly is a slip cam.

6. The multi-task tool assembly of claim 4, wherein the load tension assembly further comprises a trigger mechanism, a hub, and a tension spring;
wherein the hub is rotatable within the enclosure about a second axis, the tension spring is connected to the trigger mechanism and biases the trigger mechanism toward the hub in the secure position to secure a load tension, and rotation of the trigger mechanism away from the hub overcomes the bias of the tension spring and releases the load tension in the release position.

7. The multi-task tool assembly of claim 6, wherein the trigger mechanism includes a surface partially extended from the enclosure to receive a force to move the trigger mechanism to the release position.

8. A multi-task tool assembly comprising:
an enclosure having a first side and second side;
one or more tools and an attachment device connected between the first side and the second side at a first end of the enclosure and rotatable from a retracted position outward relative to the enclosure to an extended position; and
a load tension assembly connected within the enclosure between the first side and the second side at a second end of the enclosure.

9. The multi-task tool assembly of claim 8, wherein the first side and the second side are positioned opposite to each other, and the attachment device is rotatable about a first axis.

10. The multi-task tool assembly of claim 9, where the first end and the second end are opposite to each other.

11. The multi-task tool assembly of claim 10, wherein the one or more tools and the attachment device are rotatable about a first axis, and the load tension assembly comprises a hub positioned within the enclosure and rotatable about a second axis.

12. The multi-task tool assembly of claim 11, wherein the load tension assembly further comprises a trigger mechanism, a rotational spring, and a lateral spring each positioned within the enclosure to secure and release a load tension;
wherein the rotational spring is connected to the trigger mechanism and biases the trigger mechanism rotationally into the hub and into a secure position to secure a load tension;
wherein the lateral spring is connected to the trigger mechanism and biases the trigger mechanism laterally into the hub and into the secure position; and
wherein a force applied to the trigger mechanism in a direction opposite to the lateral bias releases the load tension.

13. A method of a multi-task tool assembly comprising;
connecting a first side to a second side to form an enclosure;
connecting one or more tools and an attachment device within the enclosure between the first side and the second side at a first end of the enclosure and rotatable between the first side and rotatable from a retracted position outward relative to the enclosure to an extended position; and
connecting a load tension assembly within the enclosure between the first side and the second side at a second end of the enclosure.

14. The method of claim 13, wherein the first side and the second side are positioned opposite to each other, and the attachment device is rotatable about a first axis.

15. The method of claim 14, where the first end and the second end are opposite to each other.

16. The method of claim 15, wherein the one or more tools and attachment device are rotatable about a first axis, and the load tension assembly comprises a hub positioned within the enclosure and rotatable about a second axis.
